(19) United States
(12) Patent Application Publication
(10) Pub. No.: US 2019/0367812 A1
(43) Pub. Date: Dec. 5, 2019

(54) LIQUID CRYSTAL COMPOSITION AND USE THEREOF

(71) Applicants: DAILY-XIANHUA OPTOELECTRONICS MATERIALS CO., LTD., Kaohsiung City (TW); Yantai Xianhua Chem-Tech Co., Ltd., Yantai (CN)

(72) Inventors: Tsung-Yu Tsai, Kaohsiung City (TW); Shu-Ling Lo, Kaohsiung City (TW); Ziqian Shi, Yantai (CN); Huan Yin, Yantai (CN); Fengmei Fang, Yantai (CN); Xiangbo Dong, Yantai (CN); Peichuan Feng, Yantai (CN)

(73) Assignees: DAILY-XIANHUA OPTOELECTRONICS MATERIALS CO., LTD., Kaohsiung City (TW); Yantai Xianhua Chem-Tech Co., Ltd., Yantai (CN)

(21) Appl. No.: 16/289,312

(22) Filed: Feb. 28, 2019

(30) Foreign Application Priority Data
May 31, 2018 (CN) 201810550832.9

(51) Int. Cl. C09K 19/44; C09K 19/30; C09K 19/34; C09K 19/12; C09K 19/20

(52) U.S. Cl. CPC C09K 19/44; C09K 2019/3063; C09K 19/3402; C09K 19/3059; C09K 19/12; C09K 19/20; C09K 2019/3422; C09K 2019/122; C09K 2019/123; C09K 2019/3004; C09K 2019/301; C09K 2019/3016; C09K 2019/3009; C09K 2019/3025; C09K 2019/3019; C09K 19/3003

(57) ABSTRACT

A liquid crystal composition includes at least one polar compound represented by Formula (I), at least one polar compound represented by Formula (II), at least one compound represented by Formula (III), at least one compound represented by Formula (IV), and at least one compound represented by Formula (V), in which Formulae (I) to (V) are as defined herein.

### CROSS-REFERENCE TO RELATED APPLICATION

This application claims priority of Chinese Patent Application No. 201810550832.9, filed on May 31, 2018.

### FIELD

The disclosure relates to a liquid crystal composition, and more particularly to a liquid crystal composition including a combination of specific compounds. The disclosure also relates to use of the liquid crystal composition in the field of liquid crystal display.

### BACKGROUND

In the field of thin film transistor liquid crystal display (TFT-LCD), in-plane switching (IPS) mode LCD and vertical alignment (VA) mode LCD are the two mainstream TFT technologies of current LCD. The IPS mode LCD, commonly known as “Super TFT”, was originally developed by Hitachi in 2001, and can enhance both horizontal viewing angle and vertical viewing angle of LCD products.

The IPS mode LCD permits liquid crystal molecules to be oriented in an opaque mode, rather than in a light-transmissive mode. Light transmittance varies depending on a voltage transverse to an orientation direction of the liquid crystal molecules. The higher the voltage, the higher the number of twisted liquid crystal molecules, such that the light transmitted through the liquid crystal molecules can be controlled precisely. The voltage only controls one deflection angle of the IPS mode liquid crystal molecules, and the number of the deflected liquid crystal molecules is approximately proportional to the voltage, such that light transmittance of a liquid crystal panel can be controlled more readily.

The VA mode LCD primarily includes multi-domain vertical alignment (MVA) technique developed by Fujitsu Corporation and patterned vertical alignment (PVA) technique developed by Samsung Corporation. The earlier developed MVA technique offers wide viewing angles, and both of the MVA and the PVA techniques can achieve a viewing angle of at least 170° via respective modifications thereof. For both of the MVA and the PVA techniques, each pixel of the LCD includes a plurality of the liquid crystal molecules that are oriented at a direction perpendicular to a glass substrate when no voltage is applied. When voltage is applied, the liquid crystal molecules shifted to a respective tilted position to obtain compensation for respective angles. Therefore, a satisfactory viewing angle can be obtained from various angles, and a relatively wide viewing angle can be achieved.

As compared to a twisted nematic (TN) panel, both VA and IPS panels have a relatively wide range of viewing angle, a relatively high contrast ratio, and a brighter color, and thus achieves a wide range of applications in the LCD field.

An IPS hard screen has significant advantages in dynamic definition, color reproduction, and viewing angle compared to a conventional soft LCD screen. The IPS hard screen has stable liquid crystal molecule arrangement and a relatively fast response speed, and thus has superior dynamic definition, completely eliminating blurry image and water ripple diffusion phenomenon produced by the soft LCD screen that is subjected to external pressure and shaking, and also precludes image sticking and smearing when displaying fast-motion video. Therefore, the IPS hard screen is widely used in the consumer, medical, aviation, automobile, and railway industries, and it is anticipated that the IPS display technology may be widely applied in various fields.

For IPS display technology, there is a need to provide a liquid crystal medium with improved performance. For motion-displaying application, the liquid crystal medium is specifically necessary to improve response time and reduce driving voltage. For certain application, the liquid crystal medium is necessary to enhance an operating temperature range. Therefore, the liquid crystal medium for the IPS display technology should possess properties of low rotational viscosity, large dielectric anisotropy, high clear point, and large k-value. The value of the dielectric anisotropy is preferably larger than 4, more preferably larger than 5, and preferably up to 15, and more preferably up to 12. When the value of the dielectric anisotropy is out of the abovementioned range, the liquid crystal medium is unfavorable due to a reasonably high resistivity and the reliability of the liquid crystal medium may be negatively affected.

Liquid crystal compositions suitable for LCD, and especially for the IPS mode LCD, have been disclosed in prior art documents such as EP0667555, DE19509410, DE19528106, JP07-181439(A), and WO9623851. However, such liquid crystal compositions have disadvantages of relatively long response time, relatively low resistivity, and/or relatively high operating voltage.

Therefore, there is a significant demand to provide a liquid crystal medium having suitable properties for practical applications, which include wide range of operating temperature, appropriate optical anisotropy, high dielectric anisotropy, low rotational viscosity, and the like.

### SUMMARY

Therefore, a first object of the disclosure is to provide a liquid crystal composition having high clear point, suitable birefringence anisotropy, high dielectric anisotropy, low rotational viscosity, and fast response speed.

A second object of the disclosure is to provide a liquid crystal display including the liquid crystal composition.

According to a first aspect of the disclosure, there is provided a liquid crystal composition, which comprises:

at least one polar compound represented by Formula (I),

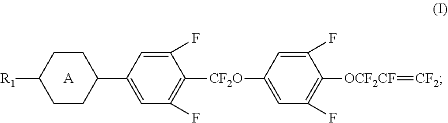

at least one polar compound represented by Formula (II),

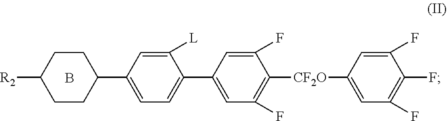

at least one compound represented by Formula (III),

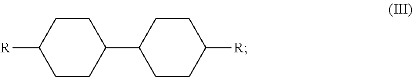

at least one compound represented by Formula (IV),

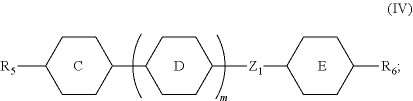

and

at least one compound represented by Formula (V),

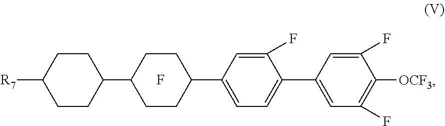

wherein

R₁ and R₂ are each independently selected from the group consisting of hydrogen, an alkyl group having 1 to 7 carbon atoms, an alkoxy group having 1 to 6 carbon atoms, an alkenyl group having 2 to 6 carbon atoms, and an alkenoxy group having 3 to 5 carbon atoms, wherein each of said alkyl group, said alkoxy group, said alkenyl group, and said alkenoxy group is unsubstituted or substituted with fluorine;

each R is independently selected from the group consisting of an alkyl group having 1 to 7 carbon atoms and an alkenyl group having 2 to 7 carbon atoms;

R₅ and R₆ are each independently selected from the group consisting of hydrogen, fluorine, an alkyl group having 1 to 7 carbon atoms, an alkenyl group having 2 to 7 carbon atoms, and an alkoxy group having 1 to 7 carbon atoms;

R₇ is selected from the group consisting of hydrogen and an alkyl group having 1 to 7 carbon atoms;

L is selected from the group consisting of hydrogen and fluorine;

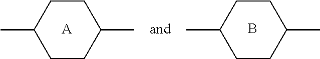

each independently represent at least one member selected from the group consisting of

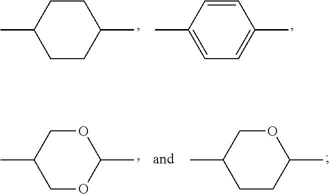

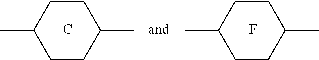

each independently represent at least one member selected from the group consisting of

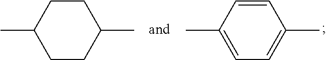

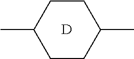

represents at least one member selected from the group consisting of

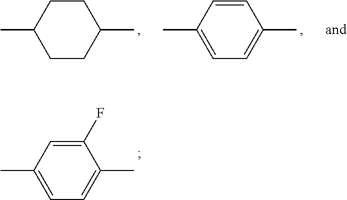

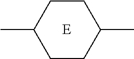

represents at least one member selected from the group consisting of

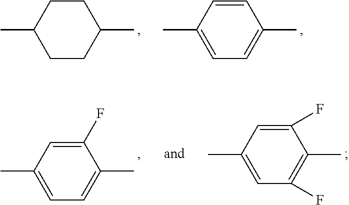

m represents 0 or 1;

Z₁ represents a single bond or a triple bond,

with the proviso that when m represents 0 and Z₁ represents a single bond,

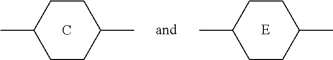

are not

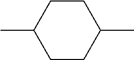

at the same time.

According to a second aspect of the disclosure, there is provided a liquid crystal display, which comprises the liquid crystal composition of the first aspect of the disclosure.

The liquid crystal composition of the disclosure is prepared via specific combination of at least one polar compound of Formula (I) that includes three cyclic moieties and a group of —OCF₂CF═CF₂ and at least one polar compound of Formula (II) that includes four cyclic moieties and a group of —CF₂O— with at least one compound of Formula (III), at least one compound of Formula (IV), and at least one compound of Formula (V), and is confirmed to have high clear point, proper birefringence anisotropy, high dielectric anisotropy, low rotational viscosity, and fast response speed so as to permit the liquid crystal composition of the disclosure to be used for TN-TFT, IPS-TFT, and FFS-TFT mode LCDs.

### DETAILED DESCRIPTION

A liquid crystal composition according to the disclosure comprises:

at least one polar compound represented by Formula (I),

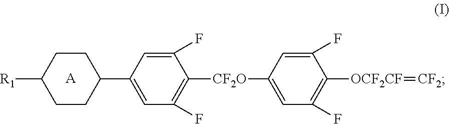

at least one polar compound represented by Formula (II),

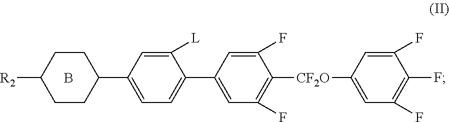

at least one compound represented by Formula (III),

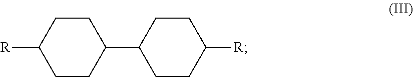

at least one compound represented by Formula (IV),

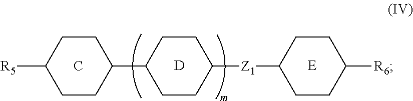

and

at least one compound represented by Formula (V),

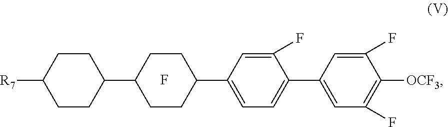

wherein

R₁ and R₂ are each independently selected from the group consisting of hydrogen, an alkyl group having 1 to 7 carbon atoms, an alkoxy group having 1 to 6 carbon atoms, an alkenyl group having 2 to 6 carbon atoms, and an alkenoxy group having 3 to 5 carbon atoms, wherein each of said alkyl group, said alkoxy group, said alkenyl group, and said alkenoxy group is unsubstituted or substituted with fluorine;

each R is independently selected from the group consisting of an alkyl group having 1 to 7 carbon atoms and an alkenyl group having 2 to 7 carbon atoms;

R₅ and R₆ are each independently selected from the group consisting of hydrogen, fluorine, an alkyl group having 1 to 7 carbon atoms, an alkenyl group having 2 to 7 carbon atoms, and an alkoxy group having 1 to 7 carbon atoms;

R₇ is selected from the group consisting of hydrogen and an alkyl group having 1 to 7 carbon atoms;

L is selected from the group consisting of hydrogen and fluorine;

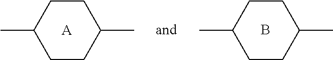

each independently represent at least one member selected from the group consisting of

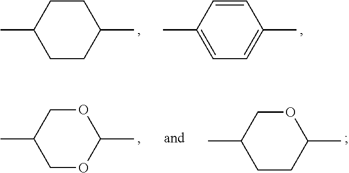

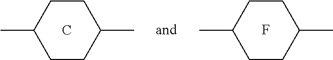

each independently represent at least one member selected from the group consisting of

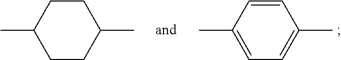

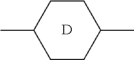

represents at least one member selected from the group consisting of

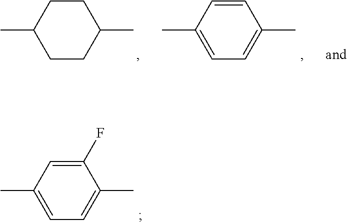

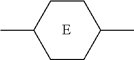

represents at least one member selected from the group consisting of

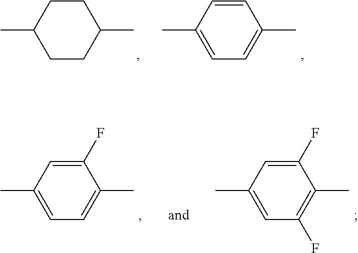

m represents 0 or 1;

Z₁ represents a single bond or a triple bond,

with the proviso that when m represents 0 and Z₁ represents a single bond,

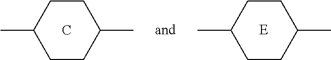

are not

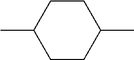

at the same time.

In certain embodiments, the polar compound represented by Formula (I) is selected from the group consisting of compounds of Formulae (I-1) to (I-9),

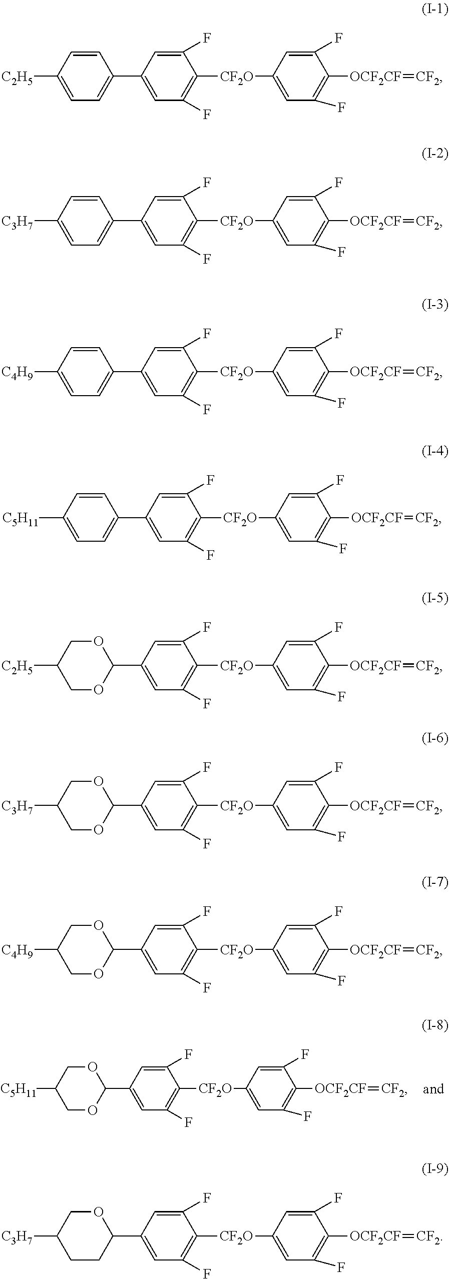

In certain embodiments, the polar compound represented by Formula (II) is selected from the group consisting of compounds of Formulae (II-1) to (II-9),

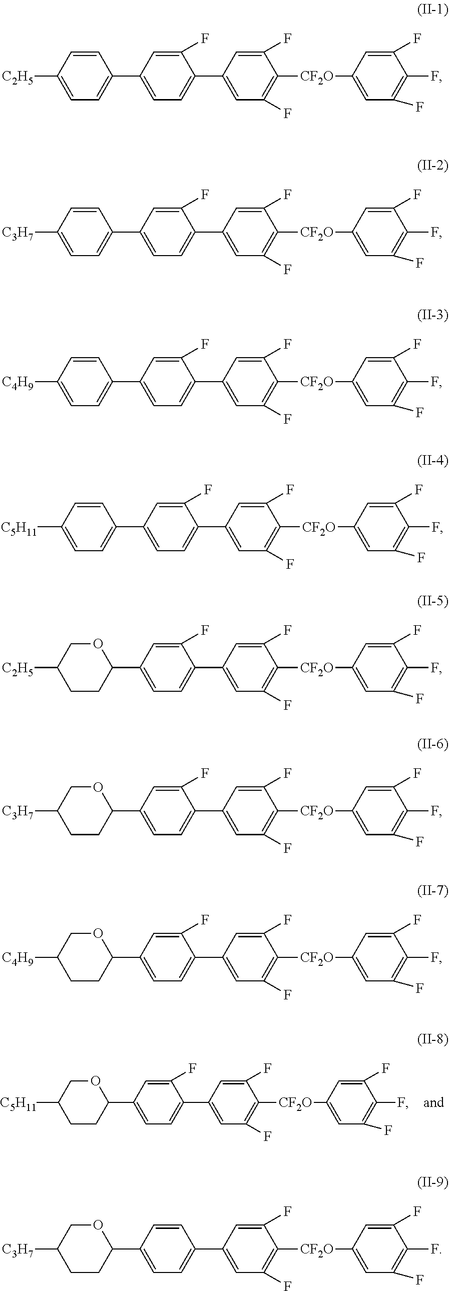

In certain embodiments, the compound represented by Formula (III) is selected from the group consisting of compounds of Formulae (III-1), (III-2), and (III-3),

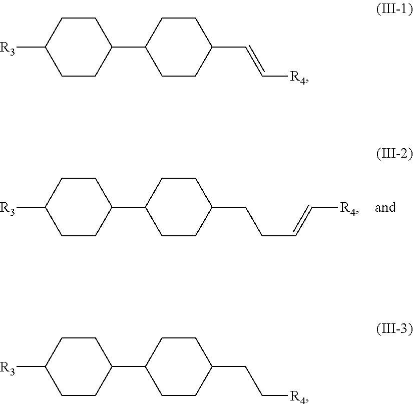

wherein

each R₃ independently represents an alkyl group having 1 to 7 carbon atoms, and

each R₄ is independently selected from the group consisting of hydrogen, CH₃, C₂H₅, and n-C₃H₇.

In certain embodiments, the compound of Formula (III-1) is selected from the group consisting of compounds of Formulae (III-1-1) to (III-1-8),

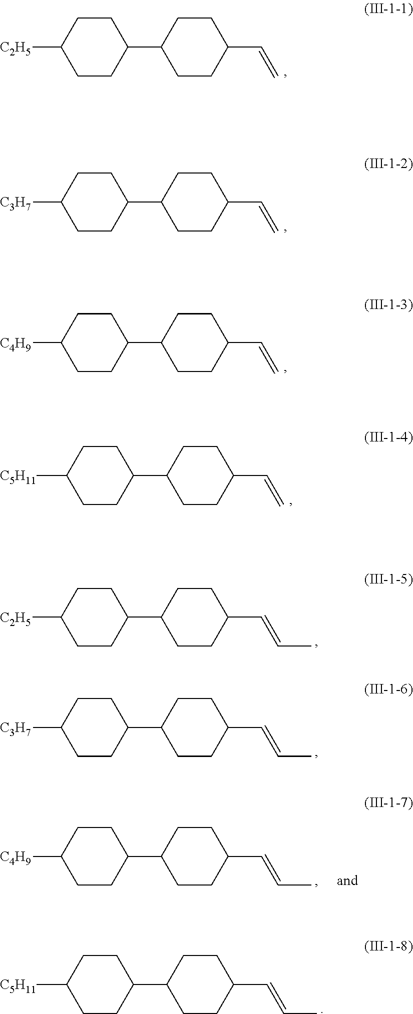

In certain embodiments, the compound of Formula (III-2) is selected from the group consisting of compounds of Formulae (III-2-1) to (III-2-4),

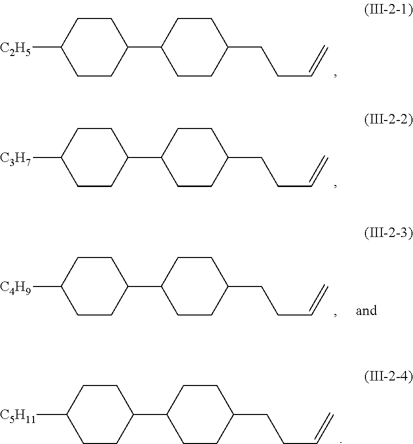

In certain embodiments, the compound of Formula (III-3) is selected from the group consisting of compounds of Formulae (III-3-1) to (III-3-6),

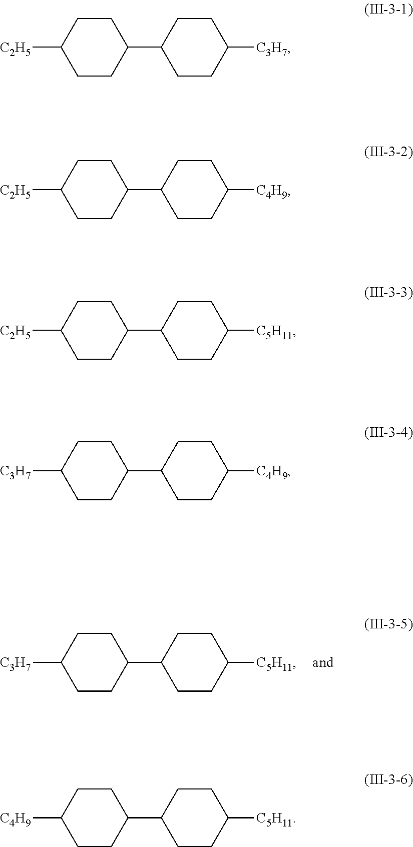

In certain embodiments, the compound represented by Formula (IV) is selected from the group consisting of compounds of Formulae (IV-1) to (IV-63),

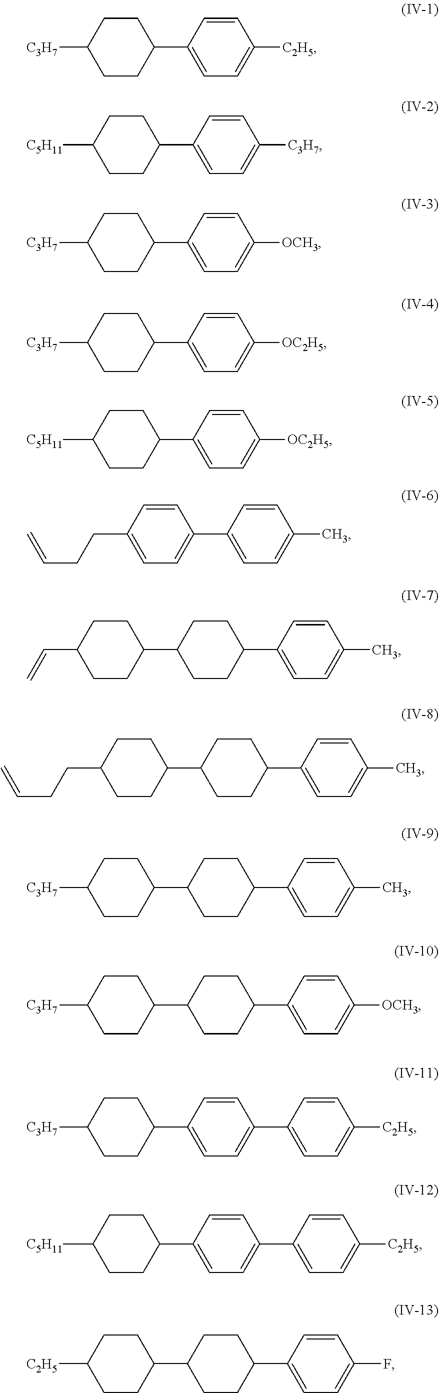

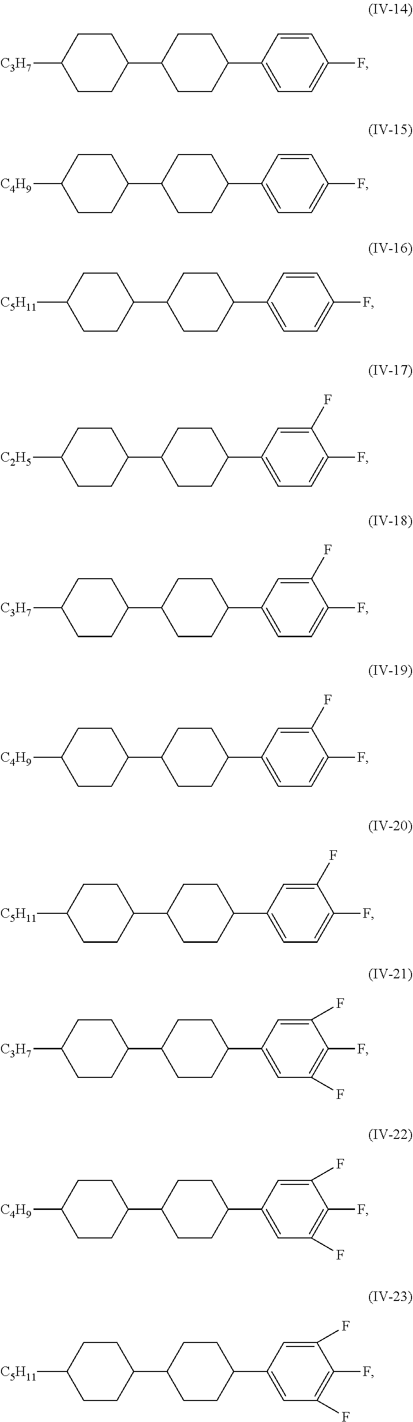

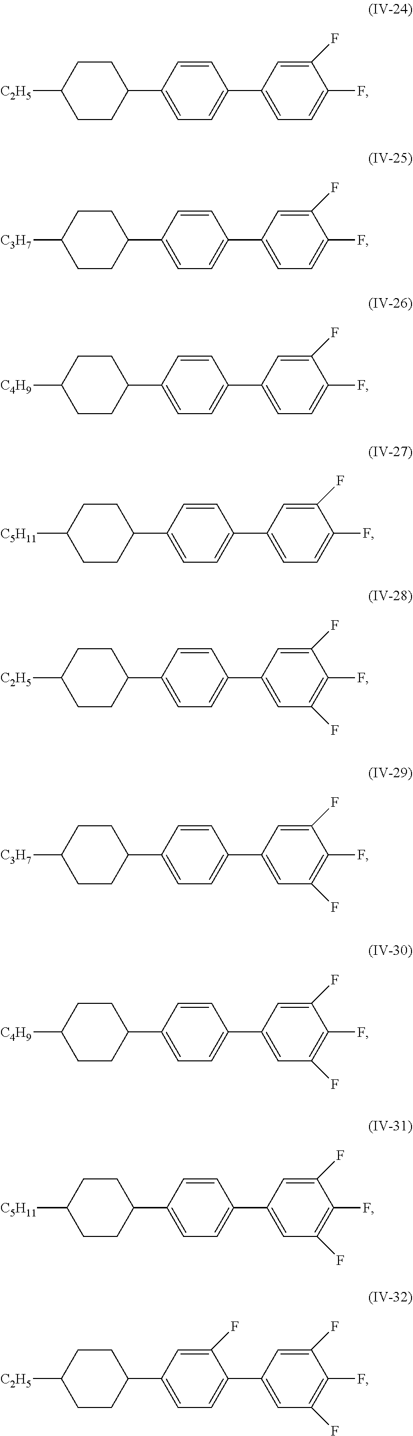

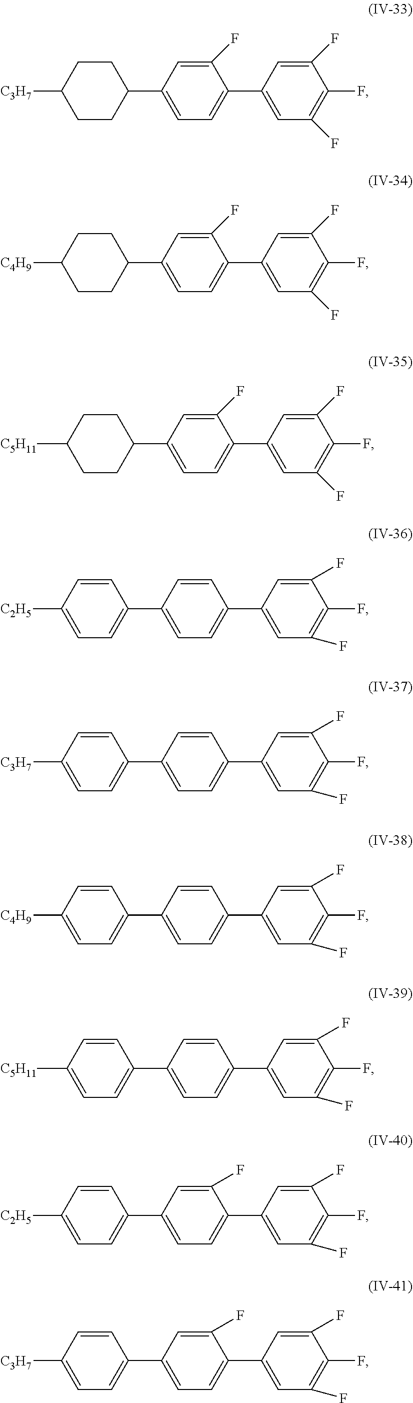

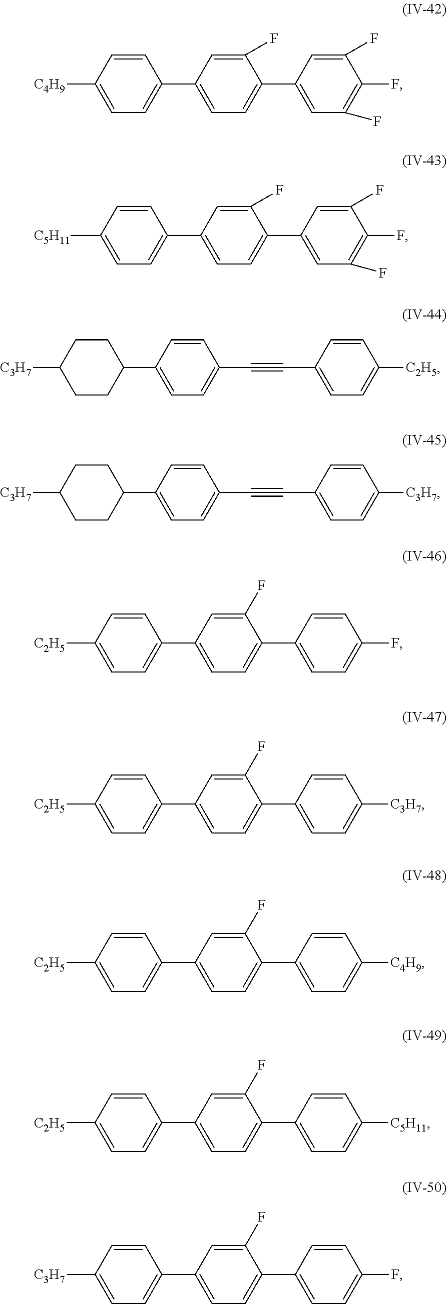

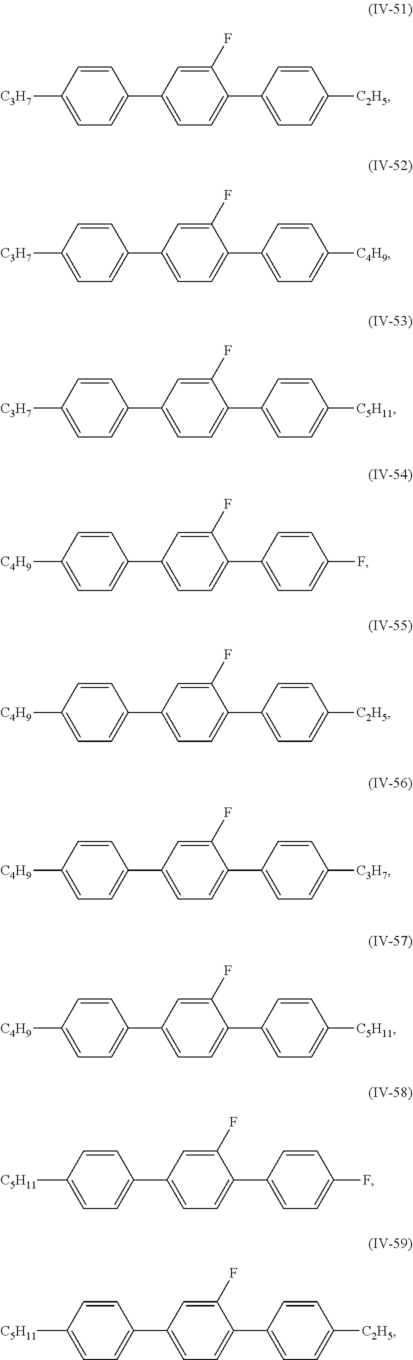

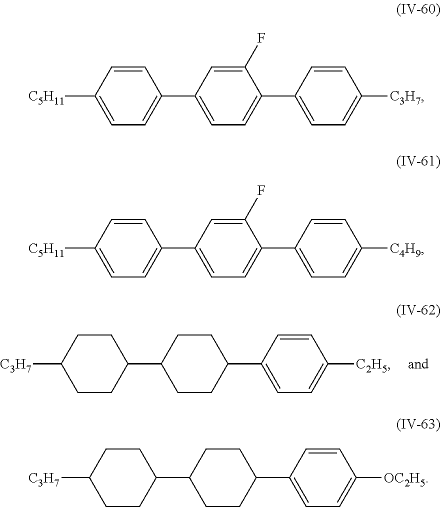

In certain embodiments, the compound represented by Formula (V) is selected from the group consisting of compounds of Formulae (V-1) to (V-8),

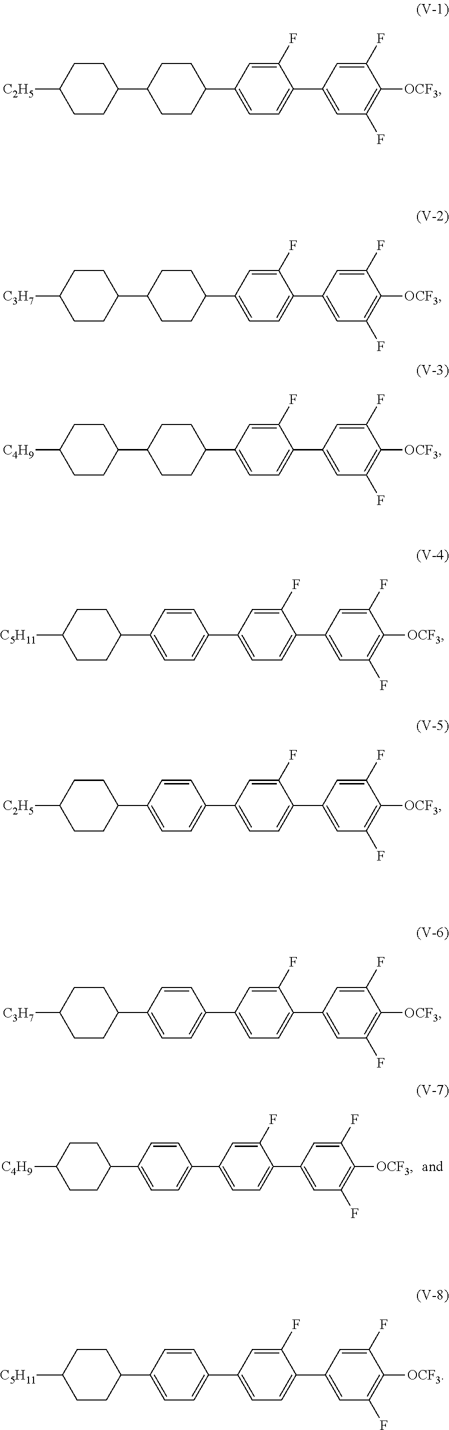

In certain embodiments, the polar compound represented by Formula (I) is in an amount ranging from 5 wt % to 30 wt %, the polar compound represented by Formula (II) is in an amount ranging from 3 wt % to 25 wt %, the compound represented by Formula (III) is in an amount ranging from 20 wt % to 60 wt %, the compound represented by Formula (IV) is in an amount ranging from 10 wt % to 45 wt %, and the compound represented by Formula (V) is in an amount ranging from 1 wt % to 20 wt % based on 100 wt % of the liquid crystal composition according to the disclosure.

A liquid crystal display according to the disclosure comprises the liquid crystal composition described above. When the liquid crystal composition according to the disclosure is used in the IPS-TFT or FFS-TFT mode liquid crystal display, it is not necessary to further add a chiral material into the liquid crystal composition. When the liquid crystal composition according the disclosure is used in the TN-TFT mode or passive matrix mode liquid crystal display, it is necessary to further add into the liquid crystal composition, the chiral material in an amount of up to 1 wt % based on a total weight of the compounds of Formulae I to V. In certain embodiments, additives such as UV stabilizers, dopants, and anti-oxidants can be added according to specific requirements.

Examples of the disclosure will be described hereinafter. It is to be understood that these examples are exemplary and explanatory and should not be construed as a limitation to the disclosure.

The liquid crystal composition according to the disclosure can be prepared by any methods well known in the art. For example, the compounds for preparing the liquid crystal composition are mixed and dissolved in an organic solvent at an elevated temperature to form a mixture, followed by removing the solvent from the mixture via distillation under reduced pressure to obtain the liquid crystal composition. Alternatively, the compound(s) having relatively low amount (s) is (are) molten in the remaining compound(s) having relatively high amount(s) at a relatively elevated temperature to prepare the liquid crystal composition. Alternatively, each of the compounds for preparing the liquid crystal composition is separately dissolved in an organic solvent (for example, acetone, chloroform, methanol, or the like), followed by mixing together in a solvent to obtain a mixture and then removing the solvent from the mixture to obtain the liquid crystal composition.

In the specification, the percentage is given by weight percentage, the temperature is given by degree Celsius, and the symbols and the measurement conditions for various properties are described below if not stated otherwise.

### 1. Clear Point (Cp, ° C.):

A liquid crystal composition was observed using a microscope while being heated using a heater. The temperature at which the liquid crystal composition transformed from a liquid crystal phase to a liquid phase was recorded as a clear point of the liquid crystal composition.

### 2. Melting Temperature (S—N, ° C.):

A liquid crystal composition was filled into a liquid crystal box, followed by placement of the liquid crystal box in a freezer at a temperature of −30° C. or −40° C. and observation of the crystalline state of the liquid crystal composition. The temperature at which the liquid crystal composition transformed from the crystalline state to a nematic phase was recorded as a melting point of the liquid crystal composition.

### 3. Optical Anisotropy (Δn):

Measurement was implemented at a wavelength of 589 nm and at a temperature of 25° C. using an Abbe refractometer (Manufacturer: Atago Co., Ltd., Japan). The optical anisotropy was calculated according to a formula as below.

Δn=ne−no,

wherein

ne is an refractive index of extraordinary light; and

no is an refractive index of ordinary light.

In order to meet the requirements for subsequent applications, the optical anisotropy (i.e., Δn) of the liquid crystal composition is preferably in a range from 0.065 to 0.200.

### 4. Dielectric Anisotropy (Δε):

A liquid crystal composition sample was placed in a 25 μm PAN cell in which no chiral dopant was added. Measurement was implemented at a temperature of 25° C. using a measurement instrument (Manufacturer: INSTEC; Model: ALCT-IR1). The dielectric anisotropy was calculated according to a formula as below.

Δε=ε∥−ε⊥,

wherein

ε∥ is a dielectric constant parallel to a molecular axis; and

ε⊥ is a dielectric constant transverse to a molecular axis.

In order to meet the requirements for subsequent applications, the dielectric anisotropy (i.e., AO of the liquid crystal composition is preferably in a range from 2 to 11.

5. Rotational Viscosity (γ1, mPa·s):

A liquid crystal composition sample was placed in a 25 μm PAN cell in which no chiral dopant was added. Measurement was implemented at a temperature of 25±0.2° C. using a measurement instrument (Manufacturer: INSTEC; Model: ALCT-IR1). The lower the rotational viscosity, the faster the response speed with the shorter the response time. In order to meet the requirements for subsequent applications, the rotational viscosity (i.e., γ1) of the liquid crystal composition is preferably in a range from 25 mPa·s to 110 mPa·s.

The liquid crystal compositions in the following examples were prepared by a heat-dissolution process or a vibration-mixing process well known in the art. Specifically, the compounds for preparing each of the liquid crystal compositions were weighed in weight percentages, and were added into a container in an unspecified order, preferably in an order in which the compound having a relatively high melting point was added before the compound having a relatively low melting point, followed by stirring or vibrating at a constant temperature of 60° C. to obtain a homogeneous mixture. The homogeneous mixture was treated via absorption, micro-filtration using a micro-filtration membrane, and then packaged to obtain a target sample.

The compounds used in the following examples can be obtained via well-known synthesis processes or via commercial purchase, and was confirmed via measurements to ensure that these compounds met the standards for electronic compounds.

For simple and clear representation, the groups contained in the compounds in the following examples are represented using the codes shown in Table 1.

TABLE 1

| Code | Group |
|---|---|
| A | 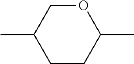 |
| B | 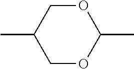 |
| C | 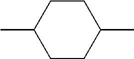 |
| D | ═ |
| E | —COO— |
| F | F |
| G | —C₂H₄— |
| H | H |
| I | —CH₂O— |
| M | 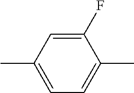 |
| N | 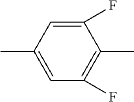 |
| O | O |
| P | 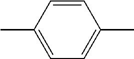 |
| Q | —CF₂O— |
| T | ≡ |
| O5FA | —OCF₂CF═CF₂ |
| OTF | —OCF₃ |
| U | 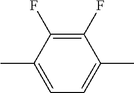 |

For example, the chemical structures of some compounds and the groups contained therein are illustrated in Table 2 below.

TABLE 2

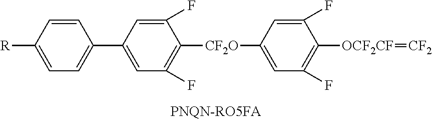

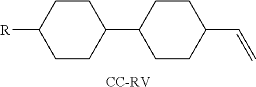

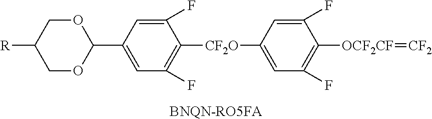

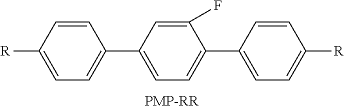

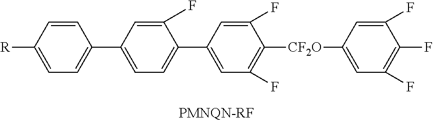

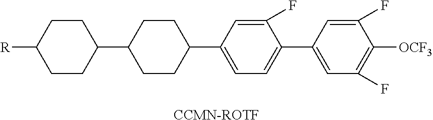

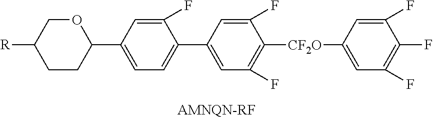

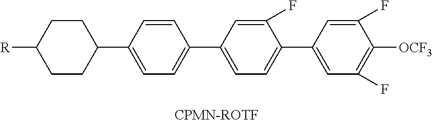

The codes, the categories, and the amounts of the compounds in Example 1, and the properties of a liquid crystal composition prepared from the compounds are summarized in Table 3 below.

TABLE 3

| Code | Category | Amount (wt %) | Properties |
|---|---|---|---|
| CC-2D3 | Formula III | 36 | S—N (° C.): ≤−40 |
| PP-41D1 | Formula IV | 4 | Cp (° C.): 89.3 |
| CCP-2D1 | Formula IV | 10 | Δ n: 0.110 |
| CCP-41D1 | Formula IV | 10 | Δ ε: 7.7 |
| PMP-2F | Formula IV | 2.5 | γ1 (mPa · s): 63 |
| PMP-3F | Formula IV | 2.5 | |
| CCP-3O1 | Formula IV | 7 | |
| PNQN-3O5FA | Formula I | 5 | |
| PNQN-5O5FA | Formula I | 5 | |
| PMNQN-3F | Formula II | 5 | |
| PMNQN-4F | Formula II | 5 | |
| AMNQN-3F | Formula II | 5 | |
| CCMN-3OTF | Formula V | 3 | |

The codes, the categories, and the amounts of the compounds in Example 2, and the properties of a liquid crystal composition prepared from the compounds are summarized in Table 4 below.

TABLE 4

| Code | Category | Amount (wt %) | Properties |
|---|---|---|---|
| CC-2D3 | Formula III | 32 | S—N (° C.): ≤−40 |
| CC-32D3 | Formula III | 4.5 | Cp (° C.): 84.4 |
| PP-41D1 | Formula IV | 4 | Δ n: 0.109 |
| CCP-2D1 | Formula IV | 10 | Δ ε: 7.7 |
| CCP-41D1 | Formula IV | 10 | γ1 (mPa · s): 61 |
| PMP-2F | Formula IV | 3 | |
| PMP-3F | Formula IV | 3 | |
| CCP-3O2 | Formula IV | 7 | |
| BNQN-3O5FA | Formula I | 5.5 | |
| PNQN-3O5FA | Formula I | 4 | |
| PNQN-5O5FA | Formula I | 4 | |
| PMNQN-3F | Formula II | 5 | |
| PMNQN-5F | Formula II | 5 | |
| CCMN-3OTF | Formula V | 3 | |

The codes, the categories, and the amounts of the compounds in Example 3, and the properties of a liquid crystal composition prepared from the compounds are summarized in Table 5 below.

TABLE 5

| Code | Category | Amount (wt %) | Properties |
|---|---|---|---|
| CC-2D3 | Formula III | 34 | S—N (° C.): ≤−30 |
| CC-32D3 | Formula III | 8 | Cp (° C.): 100 |
| PP-41D1 | Formula IV | 2 | Δ n: 0.099 |
| CCP-2D1 | Formula IV | 10 | Δ ε: 5.4 |
| CCP-41D1 | Formula IV | 10 | γ1 (mPa · s): 63 |
| CCP-32 | Formula IV | 4 | |
| PMP-3F | Formula IV | 4 | |
| CCP-3O2 | Formula IV | 7 | |
| PNQN-3O5FA | Formula I | 4 | |
| PNQN-5O5FA | Formula I | 4 | |
| PMNQN-3F | Formula II | 4 | |
| APNQN-3F | Formula II | 5 | |
| CCMN-3OTF | Formula V | 2 | |
| CCMN-5OTF | Formula V | 2 | |

The codes, the categories, and the amounts of the compounds in Example 4, and the properties of a liquid crystal composition prepared from the compounds are summarized in Table 6 below.

TABLE 6

| Code | Category | Amount (wt %) | Properties |
|---|---|---|---|
| CC-2D3 | Formula III | 33 | S—N (° C.): ≤−40 |
| CC-32D3 | Formula III | 9 | Cp (° C.): 94 |
| PP-41D1 | Formula IV | 2 | Δ n: 0.098 |
| CCP-2D1 | Formula IV | 10 | Δ ε: 4.9 |
| CCP-41D1 | Formula IV | 10 | γ1 (mPa · s): 61 |
| CCP-32 | Formula IV | 6 | |
| PMP-2F | Formula IV | 3 | |
| PMP-3F | Formula IV | 3 | |
| CCP-3O2 | Formula IV | 7 | |
| BNQN-3O5FA | Formula I | 4 | |
| PNQN-3O5FA | Formula I | 5 | |
| PMNQN-3F | Formula II | 6 | |
| CCMN-3OTF | Formula V | 2 | |

The codes, the categories, and the amounts of the compounds in Example 5, and the properties of a liquid crystal composition prepared from the compounds are summarized in Table 7 below.

TABLE 7

| Code | Category | Amount (wt %) | Properties |
|---|---|---|---|
| CC-2D3 | Formula III | 25 | S—N (° C.): ≤−30 |
| CCP-2D1 | Formula IV | 14 | Cp (° C.): 100 |
| CCP-41D1 | Formula IV | 14 | Δ n: 0.092 |
| CCP-32 | Formula IV | 6.5 | Δ ε: 9.4 |
| BNQN-3O5FA | Formula I | 8 | γ1 (mPa · s): 90 |
| BNQN-5O5FA | Formula I | 7 | |
| AMNQN-3F | Formula II | 4.5 | |
| AMNQN-4F | Formula II | 5 | |
| CCMN-3OTF | Formula V | 5 | |
| CCMN-5OTF | Formula V | 5 | |
| CPMN-3OTF | Formula V | 3 | |
| CPMN-5OTF | Formula V | 3 | |

The codes, the categories, and the amounts of the compounds in Example 6, and the properties of a liquid crystal composition prepared from the compounds are summarized in Table 8 below.

TABLE 8

| Code | Category | Amount (wt %) | Properties |
|---|---|---|---|
| CC-2D3 | Formula III | 43 | S—N (° C.): ≤−40 |
| CC-32D3 | Formula III | 12 | Cp (° C.): 80 |
| PP-41D1 | Formula IV | 5.5 | Δ n: 0.099 |
| CCP-2D1 | Formula IV | 10 | Δ ε: 2.5 |
| CCP-41D1 | Formula IV | 6 | γ1 (mPa · s): 42 |
| CPP-32 | Formula IV | 3 | |
| CPTP-32 | Formula IV | 7 | |
| PNQN-3O5FA | Formula I | 7.5 | |
| PMNQN-3F | Formula II | 3 | |
| CCMN-5OTF | Formula V | 3 | |

The codes, the categories, and the amounts of the compounds in Example 7, and the properties of a liquid crystal composition prepared from the compounds are summarized in Table 9 below.

TABLE 9

| Code | Category | Amount (wt %) | Properties |
|---|---|---|---|
| CC-2D3 | Formula III | 50 | S—N (° C.): ≤−40 |
| CCP-2D1 | Formula IV | 6 | Cp (° C.): 92 |
| CPP-32 | Formula IV | 2.5 | Δ n: 0.118 |
| PMP-2F | Formula IV | 5.5 | Δ ε: 8.0 |
| PMP-3F | Formula IV | 3.5 | γ1 (mPa · s): 63 |
| CPTP-32 | Formula IV | 5 | |
| PNQN-3O5FA | Formula I | 2.5 | |
| BNQN-3O5FA | Formula I | 4 | |
| PMNQN-4F | Formula II | 6.5 | |
| AMNQN-3F | Formula II | 6.5 | |
| CCMN-3OTF | Formula V | 4 | |
| CPMN-3OTF | Formula V | 4 | |

The codes, the categories, and the amounts of the compounds in Example 8, and the properties of a liquid crystal composition prepared from the compounds are summarized in Table 10 below.

TABLE 10

| Code | Category | Amount (wt %) | Properties |
|---|---|---|---|
| CC-2D3 | Formula III | 35 | S—N (° C.): ≤−40 |
| CC-32D3 | Formula III | 7 | Cp (° C.): 100 |
| CCP-3O1 | Formula IV | 4 | Δ n: 0.110 |
| CCP-2D1 | Formula IV | 10 | Δ ε: 4.5 |
| CCP-41D1 | Formula IV | 10 | γ1 (mPa · s): 67 |
| CPP-32 | Formula IV | 5 | |
| PMP-2F | Formula IV | 2.5 | |
| PMP-3F | Formula IV | 3.5 | |
| BNQN-5O5FA | Formula I | 4 | |
| PNQN-3O5FA | Formula I | 6 | |
| PMNQN-3F | Formula II | 5 | |
| PMNQN-4F | Formula II | 5 | |
| CPMN-3OTF | Formula V | 3 | |

The codes, the categories, and the amounts of the compounds in Example 9, and the properties of a liquid crystal composition prepared from the compounds are summarized in Table 11 below.

TABLE 11

| Code | Category | Amount (wt %) | Properties |
|---|---|---|---|
| CC-2D3 | Formula III | 45 | S—N (° C.): ≤−30 |
| CC-32D3 | Formula III | 4 | Cp (° C.): 75 |
| PP-41D1 | Formula IV | 5.5 | Δ n: 0.110 |
| CPP-32 | Formula IV | 3 | Δ ε: 4.9 |
| CPTP-32 | Formula IV | 3.5 | γ1 (mPa · s): 44 |
| CPTP-33 | Formula IV | 3.5 | |
| PMP-2F | Formula IV | 3.5 | |
| PMP-3F | Formula IV | 3.5 | |
| ANQN-5O5FA | Formula I | 9 | |
| PNQN-3O5FA | Formula I | 11.5 | |
| PMNQN-3F | Formula II | 2.5 | |
| PMNQN-4F | Formula II | 2.5 | |
| CCMN-3OTF | Formula V | 3 | |

The codes, the categories, and the amounts of the compounds in Example 10, and the properties of a liquid crystal composition prepared from the compounds are summarized in Table 12 below.

TABLE 12

| Code | Category | Amount (wt %) | Properties |
|---|---|---|---|
| CC-2D3 | Formula III | 33 | S—N (° C.): ≤−40 |
| CC-32D3 | Formula III | 6 | Cp (° C.): 80 |
| CCP-2D1 | Formula IV | 13 | Δ n: 0.102 |
| CCP-32 | Formula IV | 2 | Δ ε: 9.9 |
| PMP-2F | Formula IV | 5 | γ1 (mPa · s): 61 |
| ANQN-3O5FA | Formula I | 6 | |
| BNQN-4O5FA | Formula I | 8 | |
| PNQN-3O5FA | Formula I | 8 | |
| PMNQN-3F | Formula II | 7 | |
| PMNQN-4F | Formula II | 5.5 | |
| APNQN-3F | Formula II | 5 | |
| CCMN-3OTF | Formula V | 1.5 | |

As shown in Examples 1 to 10 above, it is confirmed that the liquid crystal composition according to the disclosure that includes a combination of specific compounds of Formulae (I) to (V), in which specific functional groups are included, have suitable properties for practical applications such as wide range of operating temperature, high clear point, appropriate birefringence anisotropy, high dielectric anisotropy, low rotational viscosity, and fast response speed.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A liquid crystal composition, comprising:
at least one polar compound represented by Formula (I), 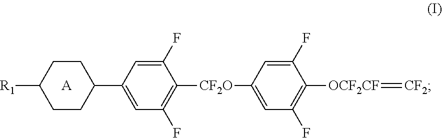
at least one polar compound represented by Formula (II), 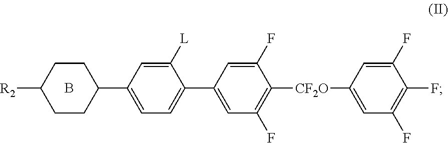
at least one compound represented by Formula (III), 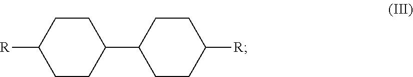
at least one compound represented by Formula (IV), 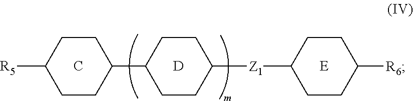
and
at least one compound represented by Formula (V), 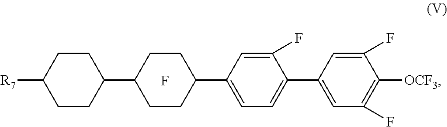
wherein
R₁ and R₂ are each independently selected from the group consisting of hydrogen, an alkyl group having 1 to 7 carbon atoms, an alkoxy group having 1 to 6 carbon atoms, an alkenyl group having 2 to 6 carbon atoms, and an alkenoxy group having 3 to 5 carbon atoms, wherein each of said alkyl group, said alkoxy group, said alkenyl group, and said alkenoxy group is unsubstituted or substituted with fluorine;
each R is independently selected from the group consisting of an alkyl group having 1 to 7 carbon atoms and an alkenyl group having 2 to 7 carbon atoms;
R₅ and R₆ are each independently selected from the group consisting of hydrogen, fluorine, an alkyl group having 1 to 7 carbon atoms, an alkenyl group having 2 to 7 carbon atoms, and an alkoxy group having 1 to 7 carbon atoms;
R₇ is selected from the group consisting of hydrogen and an alkyl group having 1 to 7 carbon atoms;
L is selected from the group consisting of hydrogen and fluorine; 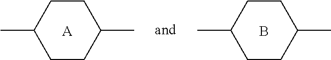
each independently represent at least one member selected from the group consisting of 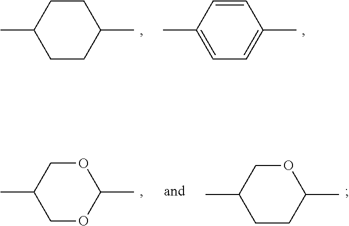 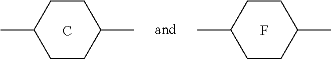
each independently represent at least one member selected from the group consisting of 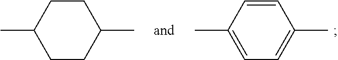 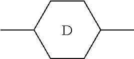
represents at least one member selected from the group consisting of 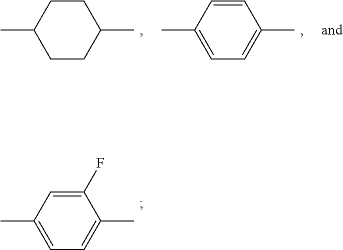 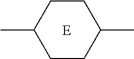
represents at least one member selected from the group consisting of 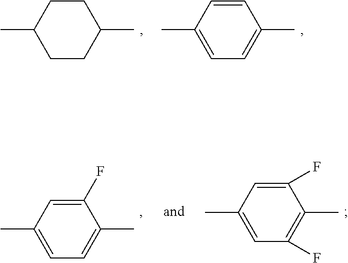
m represents 0 or 1;
Z₁ represents a single bond or a triple bond,
with the proviso that when m represents 0 and Z₁ represents a single bond, 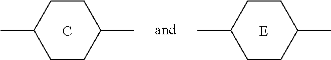
are not 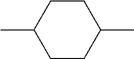
at the same time.

2. The liquid crystal composition according to claim 1, wherein said polar compound represented by Formula (I) is selected from the group consisting of compounds of Formulae (I-1) to (I-9),

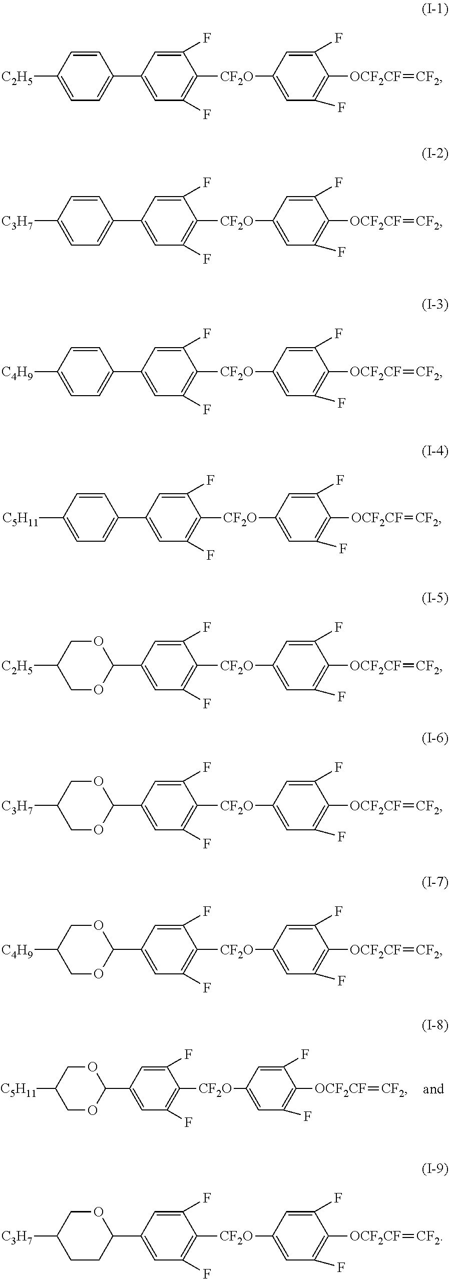

3. The liquid crystal composition according to claim 1, wherein said polar compound represented by Formula (II) is selected from the group consisting of compounds of Formulae (II-1) to (II-9),

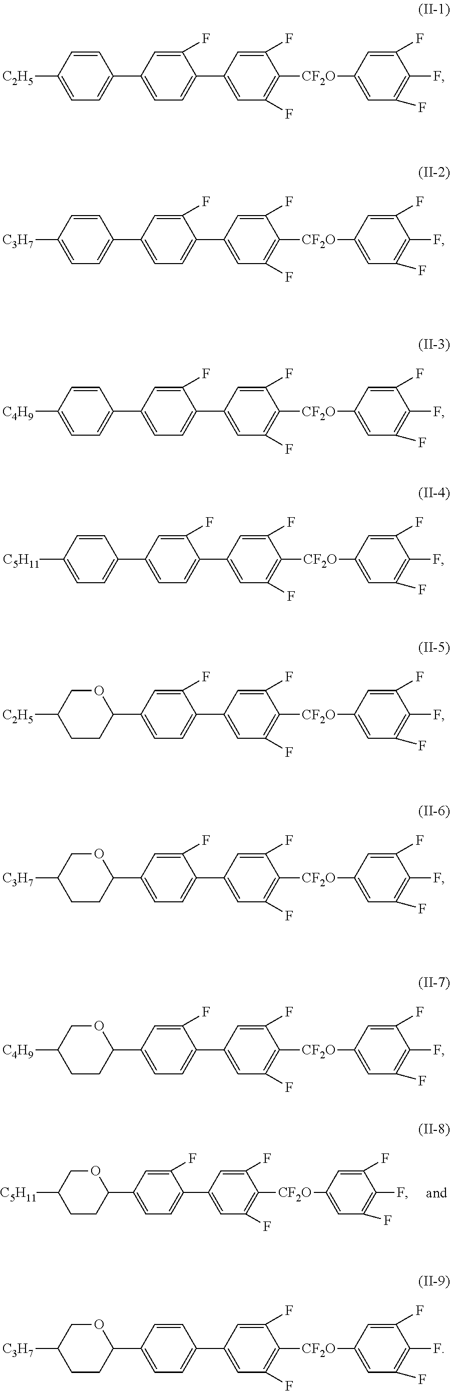

4. The liquid crystal composition according to claim 1, wherein said compound represented by Formula (III) is selected from the group consisting of compounds of Formulae (III-1), (III-2), and (III-3), 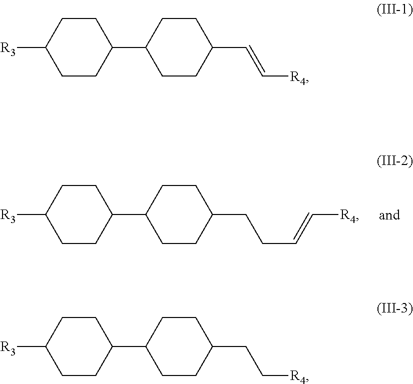
wherein
each R₃ independently represents an alkyl group having 1 to 7 carbon atoms, and
each R₄ is independently selected from the group consisting of hydrogen, CH₃, C₂H₅, and n-C₃H₇.

5. The liquid crystal composition according to claim 4, wherein
said compound of Formula (III-1) is selected from the group consisting of compounds of Formulae (III-1-1) to (III-1-8), 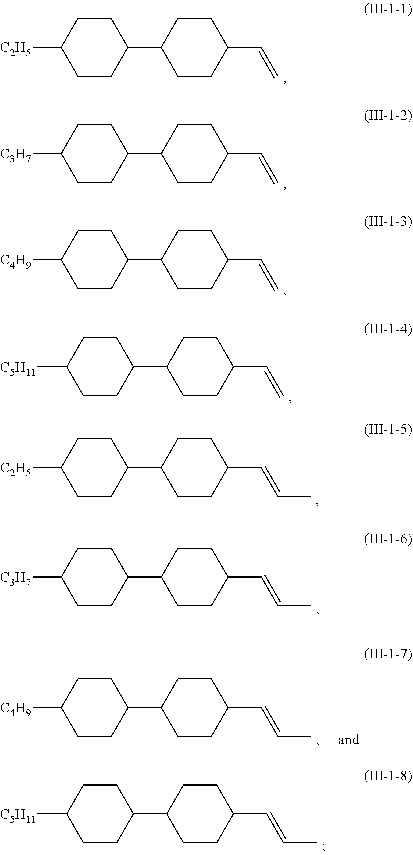
said compound of Formula (III-2) is selected from the group consisting of compounds of Formulae (III-2-1) to (III-2-4), 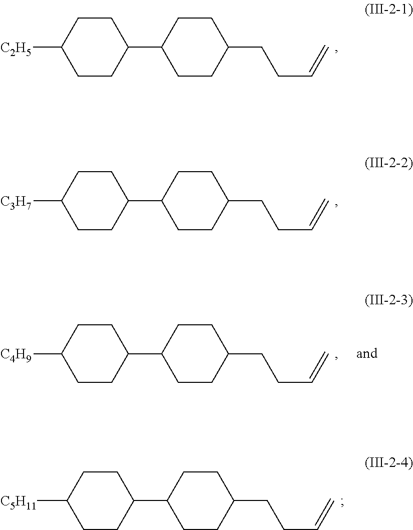
and
said compound of Formula (III-3) is selected from the group consisting of compounds of Formulae (III-3-1) to (III-3-6),

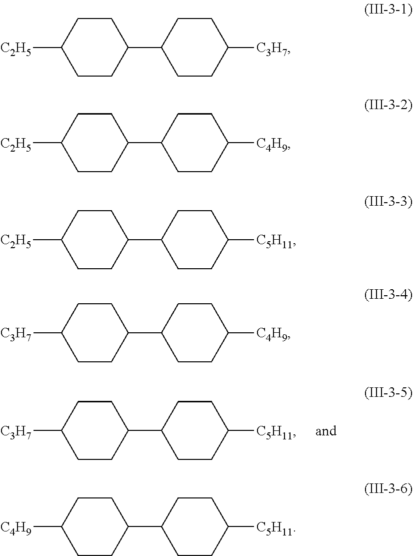

6. The liquid crystal composition according to claim 1, wherein said compound represented by Formula (IV) is selected from the group consisting of compounds of Formulae (IV-1) to (IV-63),

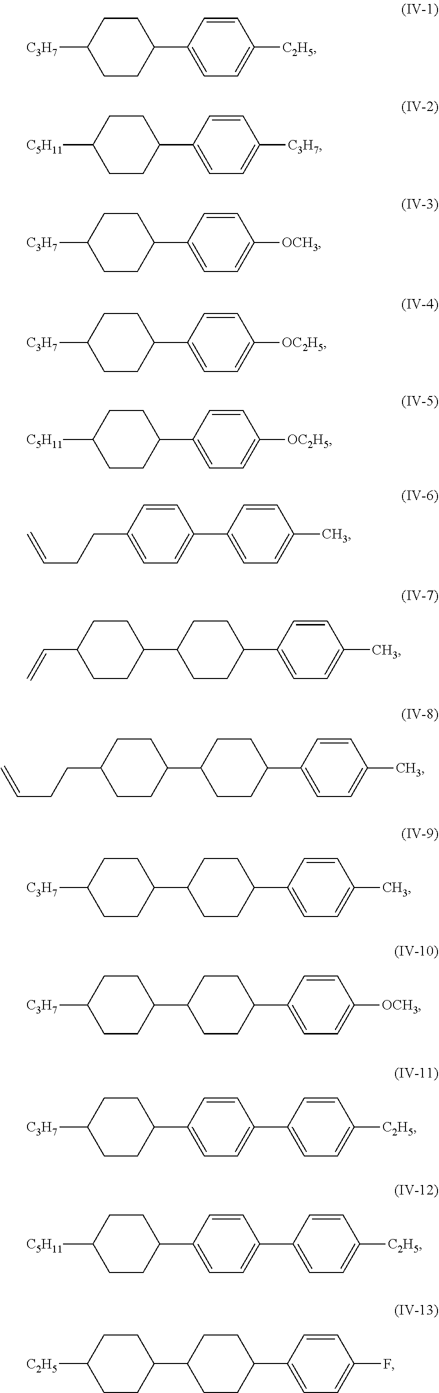

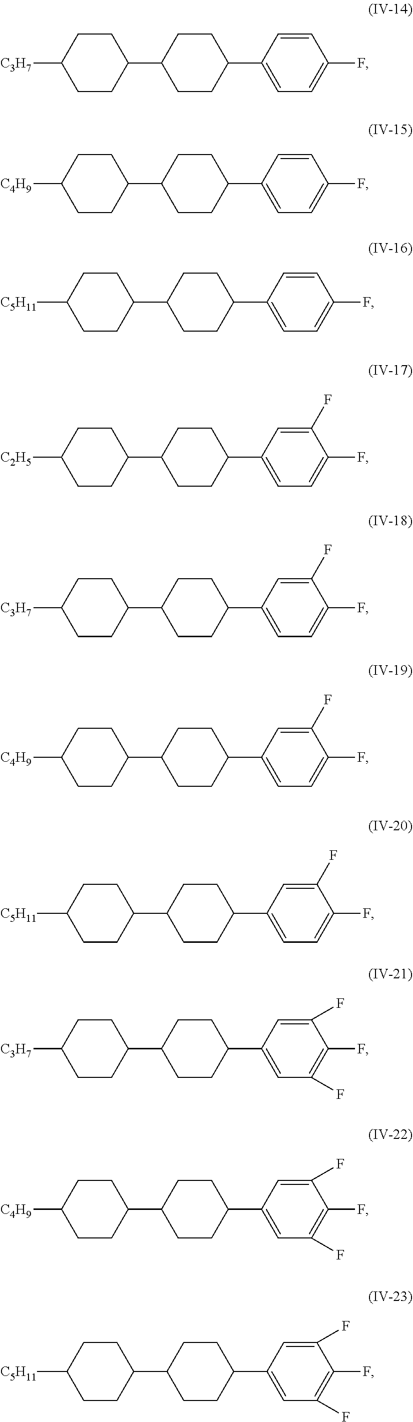

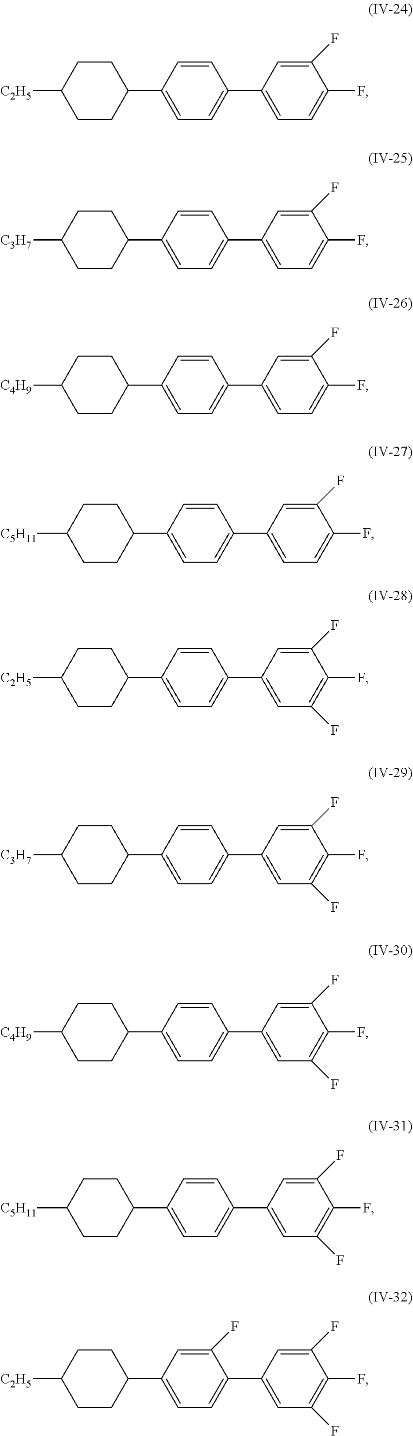

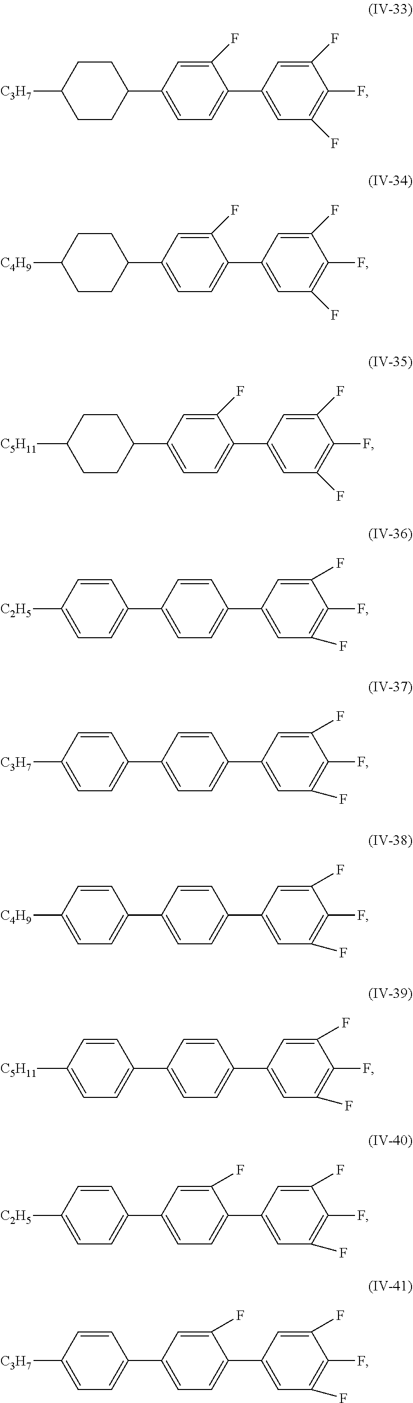

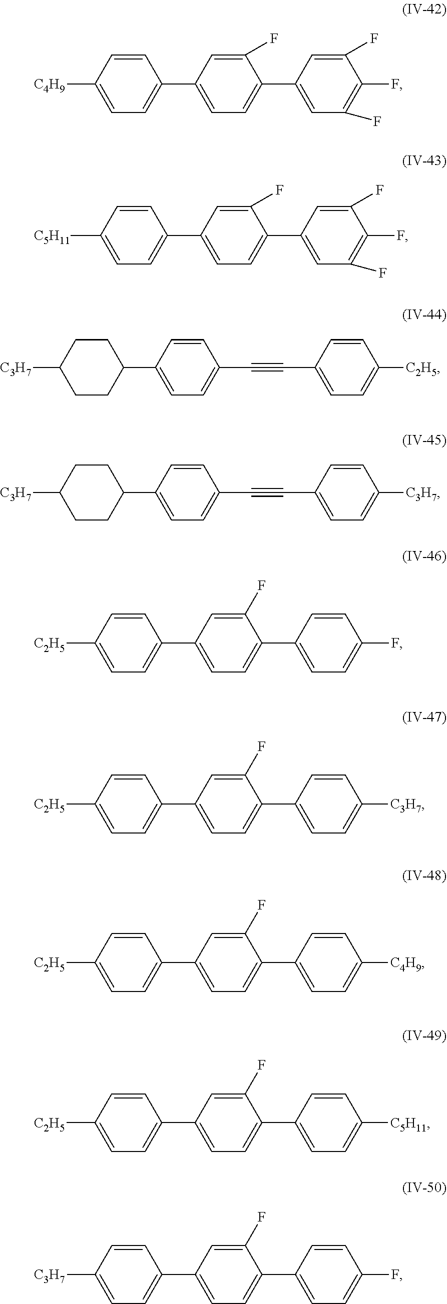

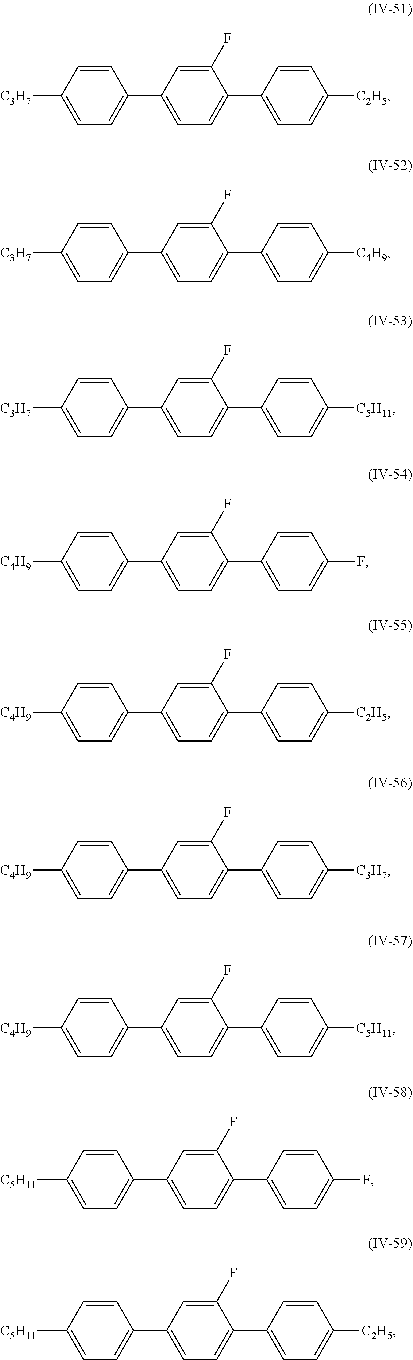

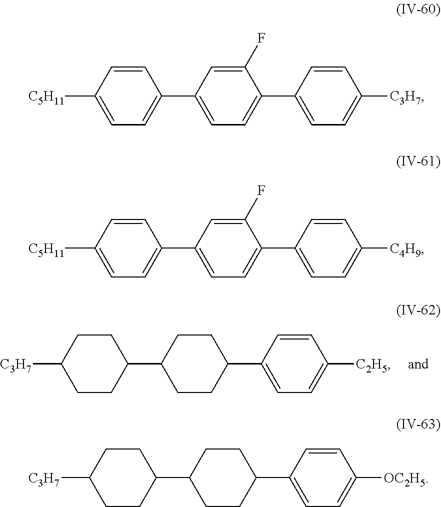

7. The liquid crystal composition according to claim 1, wherein said compound represented by Formula (V) is selected from the group consisting of compounds of Formulae (V-1) to (V-8),

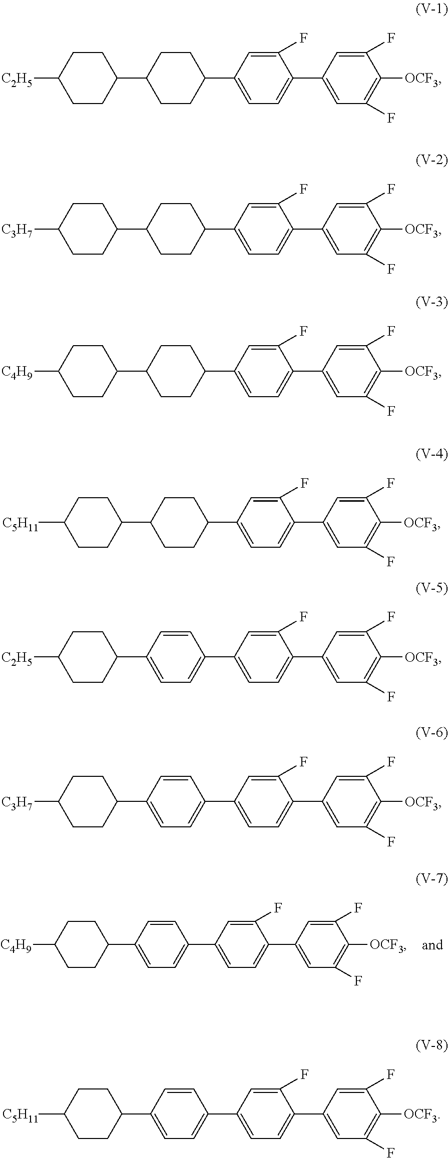

8. The liquid crystal composition according to claim 1, wherein said polar compound represented by Formula (I) is in an amount ranging from 5 wt % to 30 wt %, said polar compound represented by Formula (II) is in an amount ranging from 3 wt % to 25 wt %, said compound represented by Formula (III) is in an amount ranging from 20 wt % to 60 wt %, said compound represented by Formula (IV) is in an amount ranging from 10 wt % to 45 wt %, and said compound represented by Formula (V) is in an amount ranging from 1 wt % to 20 wt % based on 100 wt % of said liquid crystal composition.

9. A liquid crystal display comprising the liquid crystal composition according to claim 1.
